(19) United States
(12) Patent Application Publication
(10) Pub. No.: US 2025/0149691 A1
(43) Pub. Date: May 8, 2025

(54) BATTERY CELL AND BATTERY CELL MANUFACTURING METHOD

(71) Applicant: SAMSUNG SDI CO., LTD., Yongin-si (KR)

(72) Inventor: Hyun Soo LEE, Suwon-si (KR)

(21) Appl. No.: 18/754,557

(22) Filed: Jun. 26, 2024

(30) Foreign Application Priority Data
Nov. 7, 2023 (KR) 10-2023-0152514

(51) Int. Cl. H01M 50/15; H01M 10/04; H01M 50/169; H01M 50/553; H01M 50/593

(52) U.S. Cl. CPC H01M 50/15; H01M 10/049; H01M 50/169; H01M 50/553; H01M 50/593

(57) ABSTRACT

A battery cell and a battery cell manufacturing method are disclosed. A battery cell includes an electrode assembly, a cell case in which the electrode assembly is arranged, and including an opening to allow the electrode assembly to be inserted in the cell case, and a cap plate assembly arranged on the cell case to close the opening, and the cap plate assembly includes a cap plate including a first uneven surface in which a plurality of first recesses is defined, a terminal including a second uneven surface in which a plurality of second recesses is defined and which faces the first uneven surface, and a first insulator filling the plurality of first recesses and the plurality of second recesses and located between the first uneven surface and the second uneven surface.

### CROSS-REFERENCE TO RELATED APPLICATION

The present application claims priority to and the benefit of Korean Patent Application No. 10-2023-0152514, filed on Nov. 7, 2023 in the Korean Intellectual Property Office, the entire disclosure of which is incorporated herein by reference.

### BACKGROUND

### 1. Field

Aspects of embodiments of the present disclosure relate to a battery cell and a battery cell manufacturing method.

### 2. Discussion of Related Art

In general, as the demand for portable electronic products, such as laptops, video cameras, and portable phones, rapidly increases and robots, electric vehicles, and the like are commercialized in earnest, research on high-performance secondary batteries capable of repeated charging and discharging is actively underway.

Secondary batteries are widely used for driving or storing energy in small devices, such as portable electronic devices, as well as medium to large-sized devices, such as electric vehicles and energy storage systems (ESS). In particular, in the case of medium to large-sized devices, a battery module may be constituted by a plurality of battery cells, such as prismatic battery cells, electrically connected to each other to improve output and/or capacity of a battery.

A prismatic battery cell may include a cell case made of a metal material, an electrode assembly accommodated inside the cell case, and a cap plate assembly including a terminal protruding to the outside of the cell case and a cap plate for closing an open side of the cell case.

The above-described information disclosed in the technology that forms the background of the present disclosure is provided to improve understanding of the background of the present disclosure, and thus may include information that does not constitute the related art.

### SUMMARY

According to an aspect of embodiments of the present disclosure, a battery cell and a battery cell manufacturing method to insulate a cap plate and a terminal are provided.

These and other aspects and features of the present disclosure will be described in or will be apparent from the following description of some embodiments of the present disclosure.

According to one or more embodiments, a battery cell includes: an electrode assembly, a cell case in which the electrode assembly is arranged, and including an opening to allow the electrode assembly to be inserted in the cell case, and a cap plate assembly arranged on the cell case to close the opening, and the cap plate assembly includes a cap plate including a first uneven surface in which a plurality of first recesses is defined, a terminal including a second uneven surface in which a plurality of second recesses is defined and which faces the first uneven surface, and a first insulator filling the plurality of first recesses and the plurality of second recesses and located between the first uneven surface and the second uneven surface.

A size of an inner diameter of an entrance of each of the first recesses may be smaller than a size of a greatest inner diameter among sizes of inner diameters of parts other than the entrance of the first recess, and a size of an inner diameter of an entrance of each of the second recesses may be smaller than a size of a greatest inner diameter among sizes of inner diameters of parts other than the entrance of the second recess.

The first insulator may include a plurality of first hook protrusions formed by filling interiors of the plurality of first recesses with molten synthetic resin and curing the synthetic resin, and a plurality of second hook protrusions formed by filling interiors of the plurality of second recesses with the molten synthetic resin and curing the synthetic resin.

A plurality of fine recesses may be formed in at least one of the first uneven surface and the second uneven surface by laser irradiation, and the first insulator may include a plurality of fine protrusions formed by filling interiors of the plurality of fine recesses with molten synthetic resin and curing the synthetic resin.

A first through hole may be defined in the cap plate, a second through hole aligned with the first through hole may be defined in the terminal, and the cap plate assembly may further include a coupling protrusion electrically coupled to the terminal through the first through hole and the second through hole, a current collector arranged on a side opposite to the terminal with the cap plate therebetween and electrically coupled to the coupling protrusion, and a second insulator between the cap plate and the current collector.

The cap plate assembly may further include a gasket covering an inner peripheral surface of the first through hole and being in elastic contact (e.g., close contact) with the inner peripheral surface of the first through hole.

The coupling protrusion and the terminal may be coupled by welding.

The coupling protrusion may include a pillar portion extending from the current collector toward the terminal with a constant diameter, and a joint portion positioned farther from the current collector than the pillar portion and tapered such that a diameter thereof becomes smaller as a distance from the current collector increases, and the joint portion may be welded to the terminal.

The second through hole may be tapered such that a size of an inner diameter thereof becomes smaller as a distance from the cap plate increases, and a size of an inclination angle of the tapered joint portion and a size of an inclination angle of the tapered second through hole may be the same.

The coupling protrusion may further include an assembly portion tapered such that a diameter thereof becomes smaller as a distance from the current collector increases between the pillar portion and the joint portion and a size of an inclination angle of the tapered joint portion is greater than a size of an inclination angle of the tapered assembly portion.

A pair of terminals may be provided to be spaced apart from each other along a longitudinal direction of the cap plate, and a pair of first insulators may be provided and arranged in a one-to-one correspondence with the pair of terminals.

A pair of openings may be provided to be open in opposite directions in the cell case, and a pair of cap plate assemblies may be provided and arranged in a one-to-one correspondence with the pair of openings.

A pair of terminals may be provided to be spaced apart from each other along a longitudinal direction of the cap plate, and a pair of first insulators may be provided and arranged in a one-to-one correspondence with the pair of terminals.

According to one or more embodiments, a battery cell manufacturing method includes manufacturing a cap plate assembly, inserting an electrode assembly into a cell case through an opening of the cell case, and installing the cap plate assembly on the cell case to close the opening, and the manufacturing of the cap plate assembly includes preparing a cap plate comprising a first uneven surface in which a plurality of first recesses is defined, preparing a terminal comprising a second uneven surface in which a plurality of second recesses is defined, setting the cap plate and the terminal by inserting and fixing the cap plate and the terminal into an injection molding die such that the first uneven surface and the second uneven surface are arranged to face each other inside the injection molding die, molding a first insulator filling the plurality of first recesses and the plurality of second recesses and located between the first uneven surface and the second uneven surface by injecting molten synthetic resin into the injection molding die and curing the synthetic resin, and removing the cap plate assembly including the cap plate, the terminal, and the first insulator from the injection molding die.

The preparing of the cap plate may include forming a plurality of first basic grooves with a constant inner diameter from an entrance to a bottom in a surface of the cap plate by press machining, and forming a first undercut by pressing a periphery of the entrance of each of the plurality of first basic grooves such that a size of the inner diameter of the entrance of each of the plurality of first basic grooves is smaller than a size of an inner diameter of a part other than the entrance of each of the plurality of first basic grooves.

The preparing of the terminal may include forming a plurality of second basic grooves with a constant diameter from an entrance to a bottom in a surface of the terminal by press machining, and forming a second undercut by pressing a periphery of the entrance of each of the plurality of second basic grooves such that a size of the inner diameter of the entrance of each of the plurality of second basic groove is smaller than a size of an inner diameter of a part other than the entrance of each of the plurality of second basic groove.

The manufacturing of the cap plate assembly may further include forming a plurality of fine recesses by emitting a laser to at least one of the first uneven surface and the second uneven surface, and in the molding of the first insulator, the first insulator may be formed to fill the plurality of fine recesses.

The manufacturing of the cap plate assembly may further include inserting a coupling protrusion to pass through the cap plate and the terminal, and welding the coupling protrusion and the terminal, and welding a current collector to the coupling protrusion prior to welding the coupling protrusion and the terminal.

In the molding of the first insulator, a second insulator arranged to be spaced apart from the first insulator with the cap plate therebetween may be formed together with the first insulator.

The manufacturing of the cap plate assembly may further include installing a gasket on the cap plate prior to the setting of the cap plate and the terminal, and in the molding of the first insulator, the first insulator may be formed to be attached to a side of the gasket, and the second insulator may be formed to be attached to another side of the gasket.

In accordance with one or more embodiments of the present disclosure, a first insulator can be firmly coupled to a cap plate and a terminal, and a cap plate assembly including the cap plate, the terminal, and the first insulator can be easily manufactured by an insert injection molding method. Accordingly, productivity of a battery cell including the cap plate assembly can be improved and a cost thereof can be reduced.

In accordance with one or more embodiments of the present disclosure, electrical resistance between an electrode assembly and a terminal may be reduced, and thus power loss of a battery cell can be reduced and energy efficiency thereof can be improved.

However, aspects and effects obtainable through the present disclosure are not limited to the above aspects and effects, and other technical aspects and effects that are not mentioned will be clearly understood by those skilled in the art from the following description of the present disclosure.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure is not to be construed as being limited to the drawings:

FIG. 1 is a perspective view of a battery cell according to an embodiment of the present disclosure;

FIG. 2 is a cross-sectional view taken along the line II-II in FIG. 1;

FIG. 3 is an enlarged cross-sectional view illustrating a cap plate assembly of FIG. 2;

FIG. 4 is a block diagram illustrating a battery cell manufacturing method according to an embodiment of the present disclosure;

FIG. 5 is a block diagram illustrating an operation of manufacturing a cap plate assembly in FIG. 4;

FIG. 6 is a cross-sectional view for describing an operation of machining first basic grooves or an operation of machining second basic grooves in FIG. 5;

FIG. 7 is a cross-sectional view for describing an operation of forming a first undercut or an operation of forming a second undercut in FIG. 5;

FIG. 8 is a cross-sectional view for describing an operation of forming a fine recess in FIG. 5;

FIG. 9 is a cross-sectional view for describing an operation of joining a coupling protrusion and a current collector in FIG. 5;

FIG. 10 is a cross-sectional view for describing an operation of joining the coupling protrusion and a terminal in FIG. 5;

FIG. 11 is a perspective view of a battery cell according to another embodiment of the present disclosure; and

FIG. 12 is a cross-sectional view taken along the line XI-XI in FIG. 11.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

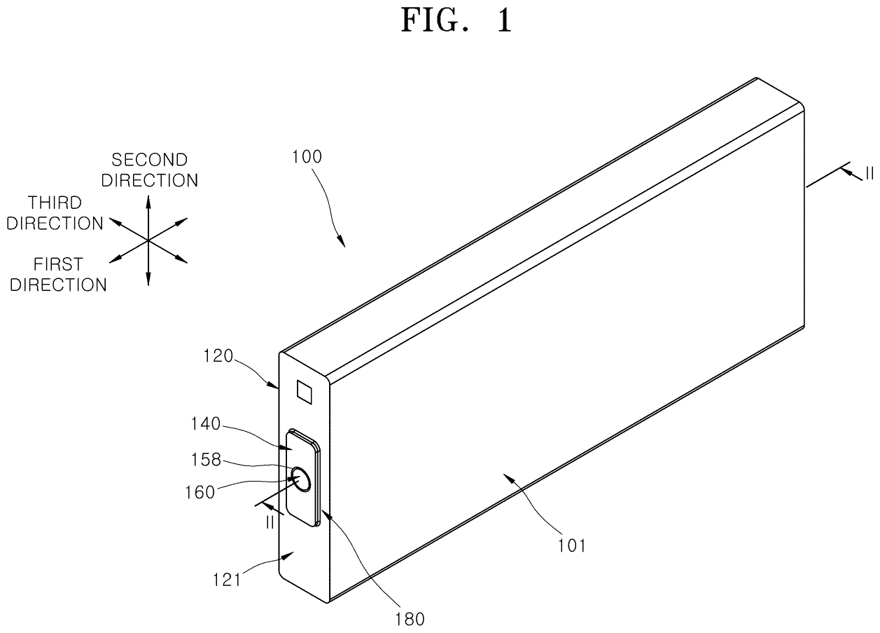

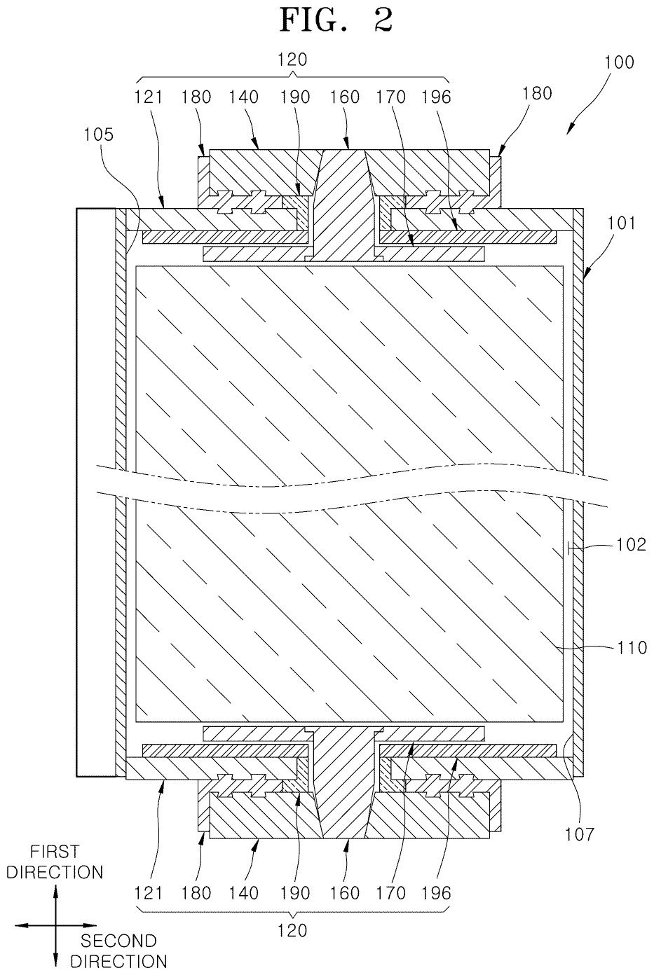

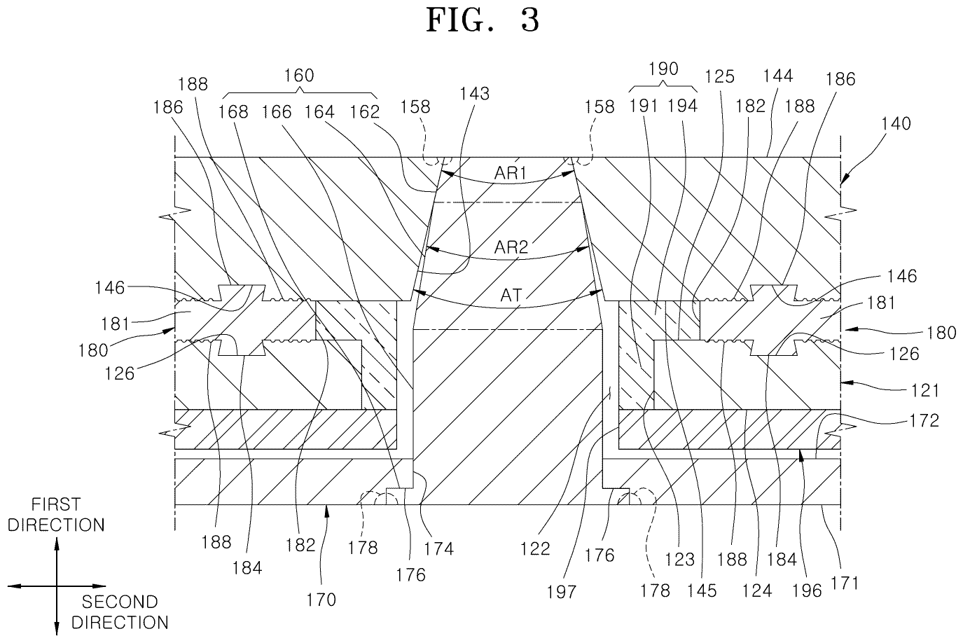

FIG. 1 is a perspective view of a battery cell according to an embodiment of the present disclosure; FIG. 2 is a cross-sectional view taken along the line II-II in FIG. 1; and FIG. 3 is an enlarged cross-sectional view illustrating a cap plate assembly of FIG. 2. Referring to FIGS. 1 to 3, a battery cell 100 according to an embodiment of the present disclosure includes a cell case 101, an electrode assembly 110, and a cap plate assembly 120. In an embodiment, the battery cell 100 may be referred to as a side type prismatic battery cell in which a pair of terminals 140 joined to a bus bar (not illustrated), that is, positive and negative terminals 140 are disposed on a first side and a second side of the cell case 101.

In an embodiment, the cell case 101 is made of a metal material, for example, an aluminum alloy, and may be formed in an approximately rectangular parallelepiped shape. An internal space 102 in which the electrode assembly 110 is stored may be formed inside the cell case 101. A first opening 105 and a second opening 107 that are open in a first direction may be formed on a first side and a second side of the cell case 101.

The electrode assembly 110 may be accommodated inside the cell case 101. The electrode assembly 110 may be inserted into the internal space 102 of the cell case 101 through the first opening 105 or the second opening 107. The electrode assembly 110 may be formed by winding or stacking a stack of a first electrode plate, a separator, and a second electrode plate, which are formed in a thin plate or film shape.

When the electrode assembly 110 is a wound stack, a winding axis may be parallel to a longitudinal direction of the cell case 101. In an embodiment, the electrode assembly 110 may be of a stack-type rather than a wound-type; however, a shape of the electrode assembly 110 is not limited in the present disclosure. In an embodiment, the electrode assembly 110 may be a Z-stack electrode assembly 110 in which positive and negative electrode plates are inserted into both sides of a separator bent into a Z-stack. In an embodiment, the electrode assembly 110 may be stored inside the cell case 101 in which one or more electrode assemblies 110 are stacked such that long sides thereof are adjacent to each other, and a number of electrode assemblies 110 is not limited in the present disclosure. The first electrode plate of the electrode assembly 110 may function as a negative electrode, and the second electrode plate may function as a positive electrode. Of course, the opposite is also possible.

The first electrode plate may be formed by coating a first electrode current collector plate made of a metal foil, such as copper, copper alloy, nickel, or nickel alloy, with a first electrode active material, such as graphite, carbon, or the like, and may include a first electrode tab (or a first uncoated portion) that is a region that is not coated with the first electrode active material. The first electrode tab may function as a path for current flow between the first electrode plate and a first current collector. In some examples, the first electrode tab may be formed in advance by cutting the first electrode plate such that the first electrode tab protrudes to a side when the first electrode plate is manufactured, and may protrude further to the side than the separator without separate cutting.

The second electrode plate may be formed by coating a second electrode current collector plate made of a metal foil, such as aluminum or aluminum alloy, with a second electrode active material, such as a transition metal oxide and the like, and may include a second electrode tab (or a second uncoated portion) that is a region that is not coated with the second electrode active material. The second electrode tab may function as a path for current flow between the second electrode plate and a second current collector. In some examples, the second electrode tab may be formed in advance by cutting the second electrode plate such that the second electrode tab protrudes to another side when the second electrode plate is manufactured, and may protrude further to the another side than the separator without separate cutting.

In some examples, the first electrode tab may be positioned on a side of a left end of the electrode assembly 110, and the second electrode tab may be positioned on a side of a right end of the electrode assembly 110, or on one side in the same direction. Here, “left” and “right” are for convenience of description, and the positions may change when the battery cell 12 rotates left or right or up and down. In some examples, the electrode assembly 110 may be accommodated in the cell case 101 together with an electrolyte.

A pair of cap plate assemblies 120 may be provided to correspond to the first opening 105 and the second opening 107 of the cell case 101. In other words, one cap plate assembly 120 of the pair of cap plate assemblies 120 may be installed on the cell case 101 to close the first opening 105, and the other cap plate assembly 120 thereof may be installed on the cell case 101 to close the second opening 107.

Each cap plate assembly 120 includes a cap plate 121, a terminal 140, and a first insulator 180. The cap plate 121 closes one of the first opening 105 and the second opening 107. In an embodiment, an outer edge of the cap plate 121 may be welded to an inner surface of one of the first opening 105 and the second opening 107 of the cell case 101.

The cap plate 121 has a first uneven surface 125 in which a plurality of first recesses 126 is formed or defined. In an embodiment, the cap plate 121 may be a plate-shaped member of which a planar shape is approximately rectangular and may extend in a second direction perpendicular to the first direction. A cap plate through hole 122 passing through the cap plate 121 in a thickness direction is formed in the cap plate 121.

Referring to FIGS. 1 to 3 and FIG. 8, the cap plate 121 may include a first side 124 facing the inside of the cell case 101, or in other words, the electrode assembly 110, and a second side 125 facing the outside of the cell case 101. A plurality of first recesses 126 and a plurality of fine recesses 132 may be formed on the second side 125. Accordingly, herein, the second side 125 of the cap plate 121 will be referred to as the first uneven surface.

A size of an inner diameter CI of an entrance 128 of each of the first recesses 126 may be smaller than a size of a greatest inner diameter CH among sizes of inner diameters of parts other than the entrance 128 of the first recess 126. A size of an inner diameter of the fine recess 132 is smaller than the size of the inner diameter CI of the entrance 128 of the first recess 126.

The terminal 140 may be made of a conductive metal material. The terminal 140 has a second uneven surface 145 in which a plurality of second recesses 146 is formed or defined. In an embodiment, the terminal 140 has a substantially rectangular parallelepiped shape, and a terminal through hole 143 passing through the terminal 140 in a thickness direction, that is, in the first direction, is formed in the terminal 140. The terminal through hole 143 and the cap plate through hole 122 may be aligned along an imaginary straight line parallel to the first direction.

The terminal 140 may include a first side 145 facing the cap plate 121 and a second side 144 opposite to the first side 145. A bus bar (not illustrated) may be joined to the second side 144. A plurality of second recesses 146 and a plurality of fine recesses 152 may be formed on the first side 145. Accordingly, herein, the first side 145 of the terminal 140 will be referred to as the second uneven surface. The second uneven surface 145 may be disposed to face the first uneven surface 125.

A size of an inner diameter TI of an entrance 148 of each of the second recesses 146 may be smaller than a size of a greatest inner diameter TH among sizes of inner diameters of parts other than the entrance 148 of the second recess 146. A size of an inner diameter of the fine recess 152 is smaller than the size of the inner diameter TI of the entrance 148 of the second recess 146.

The first insulator 180 fills the plurality of first recesses 126 and the plurality of second recesses 146 and is interposed between the first uneven surface 125 and the second uneven surface 145. The first insulator 180 may be made of an insulating material, such as a synthetic resin, for example. The first insulator 180 may include a body 181, a plurality of first hook protrusions 184, a plurality of second hook protrusions 186, and a plurality of fine protrusions 188.

The body 181 has a thickness corresponding to a gap between the first uneven surface 125 and the second uneven surface 145. The body 181 may include a portion extending along the first direction to cover an outer surface of the terminal 140.

The plurality of first hook protrusions 184 may be formed by filling interiors of the plurality of first recesses 126 with molten synthetic resin and curing the synthetic resin. Accordingly, the plurality of first hook protrusions 184 may be firmly joined to inner surfaces of the plurality of first recesses 126, and the first insulator 180 may be firmly joined to the cap plate 121.

As described above, when the size of the inner diameter CI of the entrance 128 of the first recess 126 is smaller than the size of the greatest inner diameter CH among the sizes of the inner diameters of the parts other than the entrance 128 of the first recess 126, due to a first undercut 129 generated around the entrance 128 of the first recess 126, the first hook protrusion 184 may not be separated from or come out of the first recess 126. Accordingly, the first insulator 180 may be firmly joined to the cap plate 121.

The plurality of second hook protrusions 186 may be formed by filling interiors of the plurality of second recesses 146 with molten synthetic resin and curing the synthetic resin. Accordingly, the plurality of second hook protrusions 186 may be firmly joined to inner surfaces of the plurality of second recesses 146, and the first insulator 180 may be firmly joined to the terminal 140.

As described above, when the size of the inner diameter TI of the entrance 148 of the second recess 146 is smaller than the size of the greatest inner diameter TH among the sizes of the inner diameters of the parts other than the entrance 148 of the second recess 146, due to a second undercut 149 generated around the entrance 148 of the second recess 146, the second hook protrusion 186 may not be separated from or come out of the second recess 146. Accordingly, the first insulator 180 may be firmly joined to the terminal 140.

The plurality of fine protrusions 188 may be formed by filling interiors of the plurality of fine recesses 132 and 152 with molten synthetic resin and curing the synthetic resin. Accordingly, the plurality of fine protrusions 188 may be firmly joined to inner surfaces of the plurality of fine recesses 132 and 152, and the first insulator 180 may be firmly joined to the cap plate 121 and the terminal 140.

Referring to FIGS. 1 to 3, 9, and 10, the cap plate assembly 120 may further include a coupling protrusion 160, a current collector 170, a gasket 190, and a second insulator 196. The coupling protrusion 160 may pass through the cap plate through hole 122 and the terminal through hole 143 and be electrically coupled to the terminal 140. In an embodiment, the coupling protrusion 160 may be made of a conductive metal material.

The current collector 170 may be disposed on a side opposite to the terminal 140 with the cap plate 121 interposed therebetween, and may be electrically coupled to the coupling protrusion 160. The current collector 170 may be made of a conductive metal material. In an embodiment, the current collector 170 is a plate-shaped member with a substantially square planar shape, and may extend in the second direction.

The coupling protrusion 160 may extend along the first direction. The coupling protrusion 160 may include a joint portion 162, an assembly portion 164, a pillar portion 166, and a flange portion 168. The pillar portion 166 extends in a direction from the current collector 170 toward the terminal 140. In an embodiment, a size of a diameter of the pillar portion 166 is constant along the first direction.

The joint portion 162 is positioned farther from the current collector 170 than the pillar portion 166. In an embodiment, the joint portion 162 is tapered such that a diameter thereof becomes smaller as the distance from the current collector 170 increases. The joint portion 162 may be coupled to the terminal 140 by welding, such as laser welding, for example.

The assembly portion 164 is positioned between the pillar portion 166 and the joint portion 162. In an embodiment, the assembly portion 164 is tapered such that a diameter thereof becomes smaller as the distance from the current collector 170 increases. The flange portion 168 protrudes from an outer peripheral surface of the pillar portion 166 in a radial direction perpendicular to the first direction. The flange portion 168 protrudes stepwise from the pillar portion 166, and a diameter of the flange portion 168 is greater than the diameter of the pillar portion 166.

In an embodiment, the terminal through hole 143 of the terminal 140 may be tapered such that a size of an inner diameter thereof becomes smaller as the distance from the cap plate 121 increases to correspond to the joint portion 162. In an embodiment, a size of an inclination angle AR1 of the tapered joint portion 162 and a size of an inclination angle AT of the tapered terminal through hole 143 may be the same.

When the joint portion 162 is aligned with the cap plate through hole 122 and the terminal through hole 143 and inserted into the terminal through hole 143 through the cap plate through hole 122, an outer peripheral surface of the joint portion 162 and an inner peripheral surface of the terminal through hole 143 come into surface contact, and the joint portion 162 may not come out across the terminal through hole 143. In this way, welding of the coupling protrusion 160 and the terminal 140 may be easier due to the tapered joint portion 162 and the tapered terminal through hole 143.

The size of the inclination angle AR1 of the tapered joint portion 162 may be greater than a size of an inclination angle AR2 of the tapered assembly portion 164. In other words, the size of the inclination angle AR2 of the assembly portion 164 may be smaller than the size of the inclination angle AR1 of the joint portion 162. In an embodiment, for example, the inclination angle AR1 of the joint portion 162 may be 8° to 10°, and the inclination angle AR2 of the assembly portion 164 may be 6° to 7°.

When the size of the inclination angle AR2 of the assembly portion 164 is greater than the size of the inclination angle AR1 of the joint portion 162, the outer peripheral surface of the joint portion 162 may not be in surface contact with the inner peripheral surface of the terminal through hole 143. In addition, when the size of the inclination angle AR2 of the assembly portion 164 is the same as the size of the inclination angle AR1 of the joint portion 162, even if there is a slight machining error, the outer peripheral surface of the joint portion 162 may not be in surface contact with the inner peripheral surface of the terminal through hole 143.

When a laser beam is emitted along an edge of the outer circumferential surface of the joint portion 162 and an edge of the inner peripheral surface of the terminal through hole 143 of the terminal 140 in a state in which the joint portion 162 is in surface contact with the inner peripheral surface of the terminal through hole 143, an annular weld portion 158 may be formed and, thus, the coupling protrusion 160 and the terminal 140 may be welded.

A current collector through hole 174 passing through the current collector 170 in a thickness direction is formed in the current collector 170. A size of an inner diameter of the current collector through hole 174 is greater than or equal to the diameter of the pillar portion 166 of the coupling protrusion 160 and is smaller than the diameter of the flange portion 168. The current collector 170 has a first side 171 facing the electrode assembly 110 and a second side 172 facing the cap plate 121 as a side opposite to the first side 171.

In an embodiment, an annular groove 176 is formed on the first side 171 of the current collector 170 in a stepped annular shape such that the flange portion 168 is seated. When the coupling protrusion 160 is inserted into the current collector through hole 174 such that the flange portion 168 of the coupling protrusion 160 is seated in the annular groove 176 and a laser beam is emitted along an edge of an outer peripheral surface of the flange portion 168 and an edge of the inner peripheral surface of the annular groove 176, an annular weld portion 178 may be formed and thus the coupling protrusion 160 and the current collector 170 may be welded.

Referring to FIGS. 1 to 3, the gasket 190 may cover an inner peripheral surface 123 of the cap plate through hole 122 and may come into elastic contact (e.g., close contact) with the inner peripheral surface 123 of the cap plate through hole 122. The gasket 190 may be made of an elastic material with insulating properties. In an embodiment, the gasket 190 may include a tubular gasket pipe portion 191 extending in the first direction, and a gasket flange portion 194 extending in a radial direction such that a diameter of the gasket pipe portion 191 increases.

An end of the gasket pipe portion 191 may be attached to the second insulator 196, and another end may be connected to the gasket flange portion 194. An outer peripheral surface of the gasket flange portion 194 may be in close contact with the body 181 of the first insulator 180.

A side of the gasket flange portion 194 may be in close contact with a portion of the first uneven surface 125 that is not covered by the first insulator 180, and another side of the gasket flange portion 194 may be in close contact with a portion of the second uneven surface 145 that is not covered by the first insulator 180. An end of the gasket flange portion 194 that is farthest from the coupling protrusion 160 may be attached to the first insulator 180.

The second insulator 196 is interposed between the cap plate 121 and the current collector 170 to insulate the cap plate 121 and the current collector 170. The second insulator 196 may be made of an insulating material, such as a synthetic resin, for example.

The current collector 170 included in the cap plate assembly 120 closing the first opening 105 may be electrically connected to the uncoated portion of one of the first electrode plate and the second electrode plate of the electrode assembly 110, and the current collector 170 included in the cap plate assembly 120 closing the second opening 107 may be electrically connected to the uncoated portion of the other one of the first electrode plate and the second electrode plate of the electrode assembly 110.

The current collector 170 may be directly electrically connected to the uncoated portion by a method such as welding or may be electrically connected to the uncoated portion via a sub-plate (not illustrated).

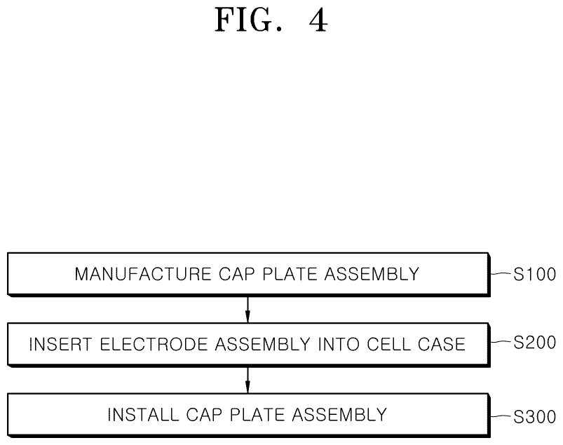

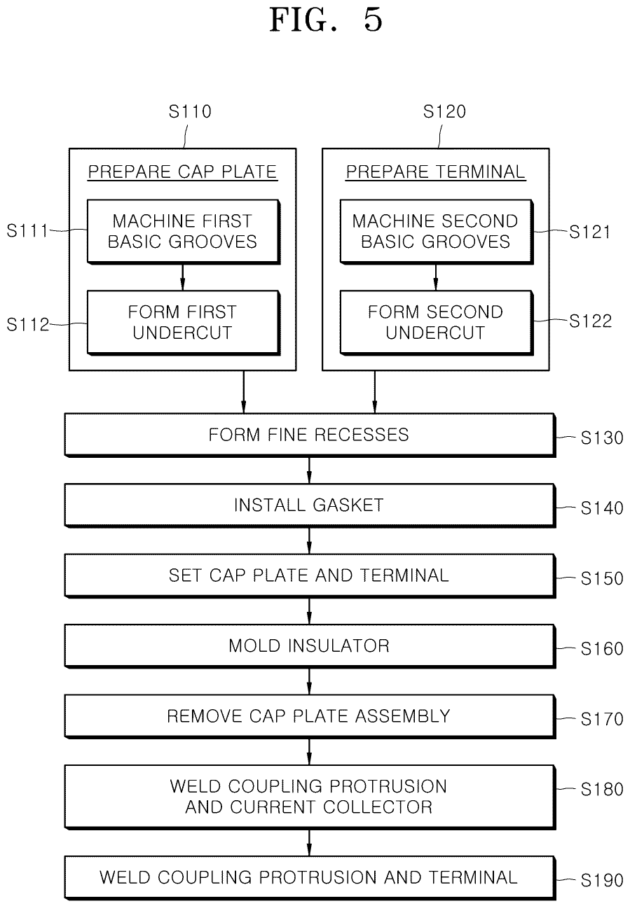

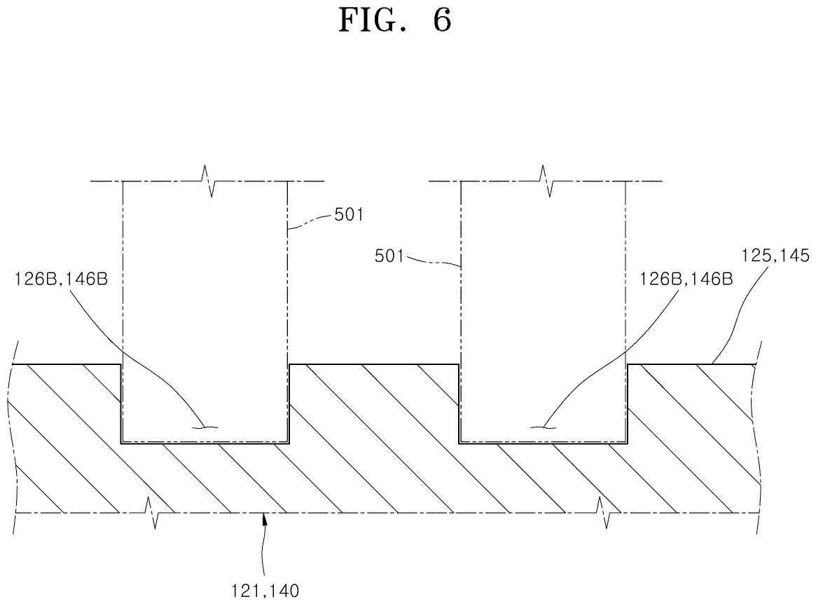

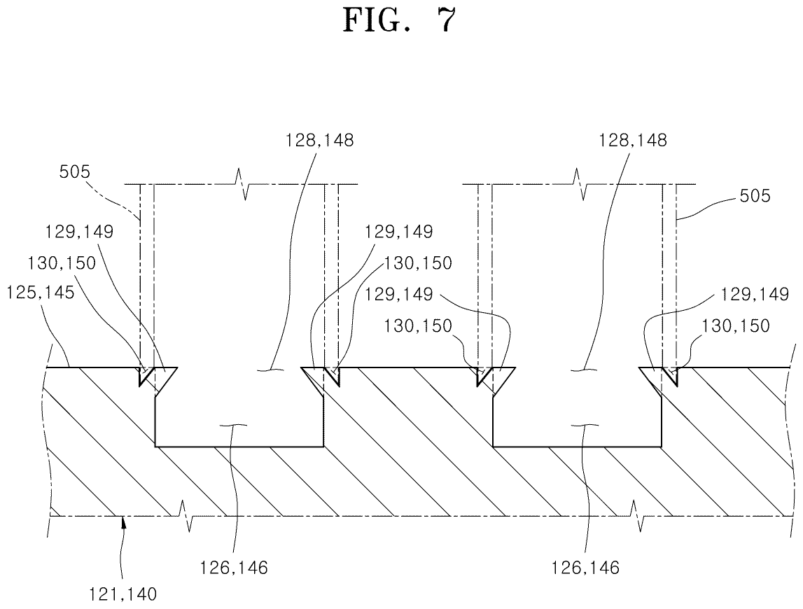

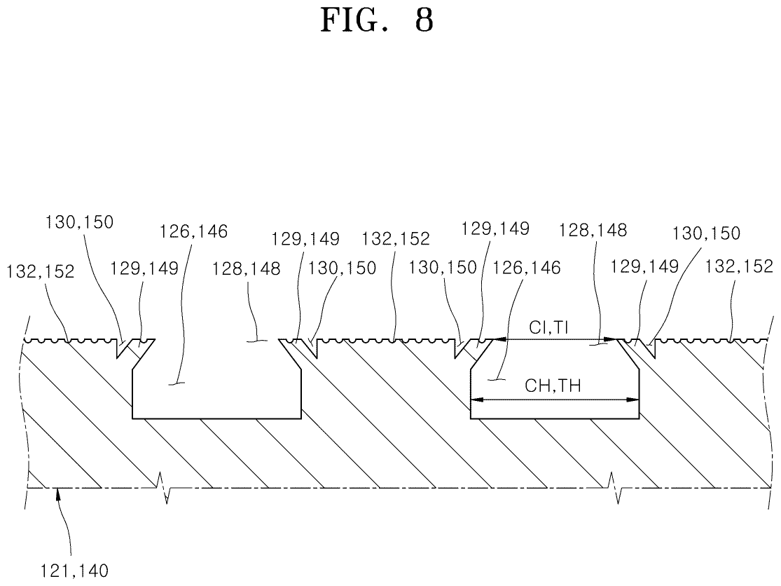

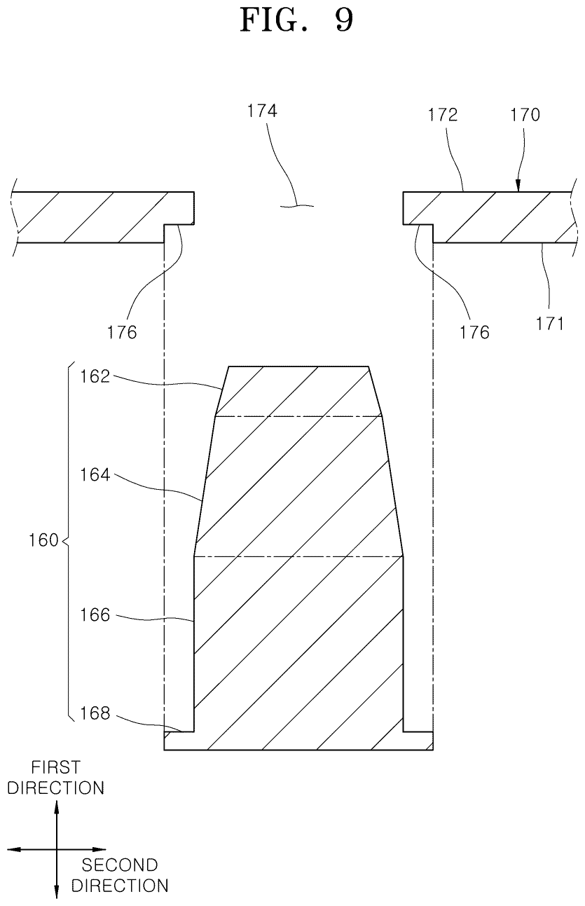

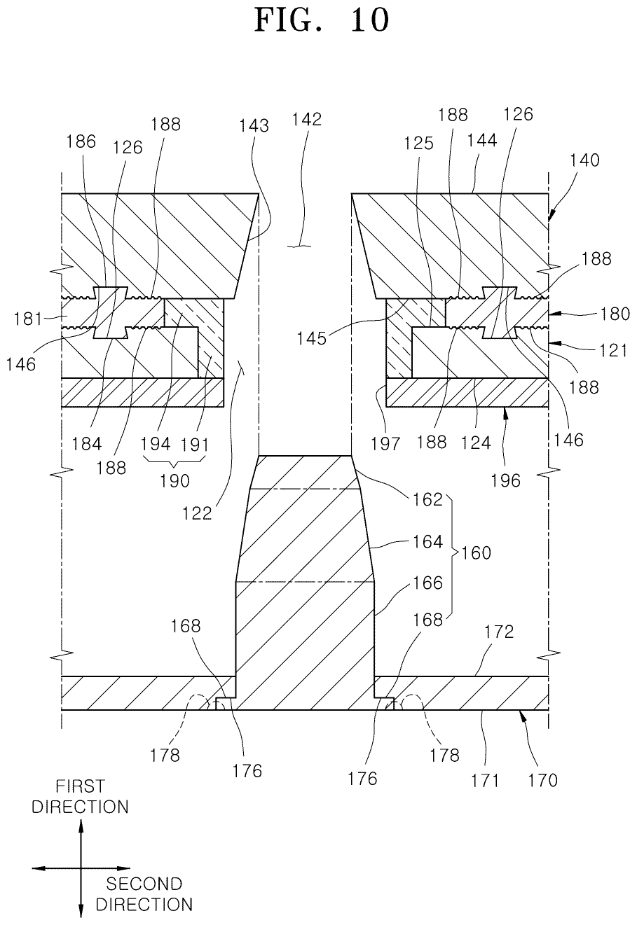

FIG. 4 is a block diagram illustrating a battery cell manufacturing method according to an embodiment of the present disclosure; FIG. 5 is a block diagram illustrating an operation of manufacturing a cap plate assembly in FIG. 4; FIG. 6 is a cross-sectional view for describing an operation of machining first basic grooves or an operation of machining second basic grooves in FIG. 5; FIG. 7 is a cross-sectional view for describing an operation of forming a first undercut or an operation of forming a second undercut in FIG. 5; FIG. 8 is a cross-sectional view for describing an operation of forming a fine recess in FIG. 5; FIG. 9 is a cross-sectional view for describing an operation of joining a coupling protrusion and a current collector in FIG. 5; and FIG. 10 is a cross-sectional view for describing an operation of joining the coupling protrusion and a terminal in FIG. 5.

Referring to FIGS. 1 to 10, the battery cell manufacturing method according to an embodiment of the present disclosure includes an operation of manufacturing a cap plate assembly (S100), an operation of inserting an electrode assembly into a cell case (S200), and an operation of installing the cap plate assembly (S300).

The operation of manufacturing a cap plate assembly (S100) includes, as an operation of manufacturing the cap plate assembly 120, an operation of preparing a cap plate (S110), an operation of preparing a terminal (S120), an operation of setting the cap plate and the terminal (S150), an operation of molding an insulator (S160), and an operation of removing the cap plate assembly (S170).

The operation of preparing a cap plate (S110) is an operation of preparing the cap plate 121 having the first uneven surface 125 in which the plurality of first recesses 126 is formed. The operation of preparing a cap plate (S110) may include an operation of machining first basic grooves (S111) and an operation of forming a first undercut (S112) to form the plurality of first recesses 126.

Referring to FIG. 6, in an embodiment, the operation of machining first basic grooves (S111) is an operation of forming a plurality of first basic grooves 126B with a constant inner diameter from an entrance to a bottom in the surface of the cap plate 121, specifically the first uneven surface 125, by press machining. In an embodiment, for example, the plurality of first basic grooves 126B may be machined using a press mold equipped with a plurality of first punches 501 having a substantially cylindrical shape.

Referring to FIGS. 6 to 8, the operation of forming a first undercut (S112) is an operation of forming the first undercut 129 by pressing a periphery of the entrance of each of the plurality of first basic grooves 126B such that a size of the inner diameter of the entrance of each of the plurality of first basic grooves 126B is smaller than a size of an inner diameter of a part other than the entrance of each of the plurality of first basic grooves 126B.

Through the operation of forming a first undercut (S112), the first recess 126 in which the size of the inner diameter CI of the entrance 128 is smaller than the size of the inner diameter CH of a part other than the entrance 128 may be formed.

In an embodiment, the first undercut 129 may be formed by press machining. For example, the first undercut 129 may be formed by pressing the periphery of the entrance of the first basic groove 126B using a press mold equipped with a plurality of tubular second punches 505 each having an inner diameter slightly greater than the diameter of the cylindrical first punch 501. As an end of each of the second punches 505 presses the first uneven surface 125, an annular groove 130 may be formed in the first uneven surface 125.

Referring to FIGS. 3 to 10, the operation of preparing a terminal (S120) is an operation of preparing the terminal 140 having the second uneven surface 145 in which the plurality of second recesses 146 is formed. The operation of preparing a terminal (S120) may include an operation of machining second basic grooves (S121) and an operation of forming a second undercut (S122) to form the plurality of second recesses 146.

Referring to FIG. 6, in an embodiment, the operation of machining second basic grooves (S121) is an operation of forming a plurality of second basic grooves 146B with a constant inner diameter from an entrance to a bottom in the surface of the terminal 141, specifically the second uneven surface 145 by press machining. For example, the plurality of second basic grooves 146B may be machined using a press mold equipped with the plurality of first punches 501 having a substantially cylindrical shape.

Referring to FIGS. 6 to 8, the operation of forming a second undercut (S122) is an operation of forming the second undercut 149 by pressing a periphery of the entrance of each of the plurality of second basic grooves 146B such that a size of the inner diameter of the entrance of each of the plurality of second basic grooves 146B is smaller than a size of an inner diameter of a part other than the entrance of each of the plurality of second basic grooves 146B.

Through the operation of forming a second undercut (S122), the second recess 146 in which the size of the inner diameter TI of the entrance 148 is smaller than the size of the inner diameter TH of a part other than the entrance 148 may be formed.

In an embodiment, the second undercut 149 may be formed by press machining. For example, the second undercut 149 may be formed by pressing the periphery of the entrance of the second basic groove 146B using a press mold equipped with a plurality of tubular second punches 505 each having an inner diameter slightly greater than the diameter of the cylindrical first punch 501. As an end of each of the second punches 505 presses the second uneven surface 145, an annular groove 150 may be formed in the second uneven surface 145.

The operation of manufacturing a cap plate assembly (S100) may further include an operation of forming fine recesses (S130). In an embodiment, the operation of forming fine recesses (S130) is an operation of forming a plurality of fine recesses 132 and 152 as illustrated in FIG. 8 by emitting a laser beam to at least one of the first uneven surface 125 and the second uneven surface 145.

The operation of setting the cap plate and the terminal (S150) is an operation of inserting and fixing the cap plate 121 and the terminal 140 into an injection molding die (not illustrated) such that the first uneven surface 125 and the second uneven surface 145 are disposed to face each other inside the injection molding die.

The injection molding die includes an upper molding die and a lower molding die that form a cavity therebetween when they are brought into close contact. When the upper and lower molding dies of the injection molding die are spaced apart, the cap plate 121 and the terminal 140 are mounted on the upper molding die or the lower molding die, and the upper and lower molding dies are brought into close contact, the cap plate 121 and the terminal 140 may be inserted and fixed inside the injection molding die.

Referring to FIGS. 3 to 10, the operation of molding an insulator (S160) is an operation of forming the first insulator 180 filling the plurality of first recesses 126 and the plurality of second recesses 146 and interposed between the first uneven surface 125 and the second uneven surface 145 by injecting molten synthetic resin into the injection molding die and curing the synthetic resin.

In the operation of molding an insulator (S160), the plurality of first hook protrusions 184 and the plurality of second hook protrusions 186 may be formed. In addition, by filling the plurality of fine recesses 132 and 152 with the synthetic resin and curing the synthetic resin, the plurality of fine protrusions 188 may be formed.

The operation of removing the cap plate assembly (S170) is an operation of removing the cap plate assembly 120 including the cap plate 121, the terminal 140, and the first insulator 180 from the injection molding die. The upper and lower molding dies of the injection molding die may be separated, and the cap plate assembly 120 may be separated and removed from the injection molding die.

The operation of manufacturing a cap plate assembly (S100) may further include an operation of installing a gasket (S140), an operation of welding the coupling protrusion and the current collector (S180), and an operation of welding the coupling protrusion and the terminal (S190).

The operation of installing a gasket (S140) is an operation of installing the gasket 190 on the cap plate 121, prior to the operation of setting the cap plate and the terminal (S150). For example, the gasket 190 may be installed on the cap plate 121 such that the gasket 190 covers an inner peripheral surface 123 of the cap plate through hole 122 and comes into elastic close contact with the inner peripheral surface 123 of the cap plate through hole 122. Since a configuration and function of the gasket 190 has been described with reference to FIG. 3, a redundant description thereof will be omitted.

In an embodiment, the shape of the cavity formed by close contact between the upper molding die and the lower molding die of the injection molding die may correspond to a combined shape of the cap plate 121, the terminal 140, the first insulator 180, the second insulator 196, and the gasket 190.

In this case, when the molten synthetic resin is injected and cured into the inside of the injection molding die in the operation of molding an insulator (S160), the second insulator 196 disposed to be spaced apart from the first insulator 180 with the cap plate 121 therebetween may be formed together with the first insulator 180.

The first insulator 180 and the second insulator 196 may be formed to be spaced apart with the gasket 190 therebetween. The first insulator 180 may be formed to be attached to a side of the gasket 190, and the second insulator 196 may be formed to be attached to another side of the gasket 190. For example, the first insulator 180 may be attached to a lower end of the gasket pipe portion 191 included in the gasket 190.

The second insulator 196 may be attached to an end of the gasket flange portion 194 included in the gasket 190. The second insulator 196 may be formed to be attached to the first side 124 of the cap plate 121 toward the electrode assembly 110. The temperature of the molten synthetic resin is lower than the melting temperature of the gasket 190, and the gasket 190 may not be melted inside the injection molding die.

Referring to FIGS. 3, 5, and 9, the operation of welding the coupling protrusion and current collector (S180) is an operation of welding the current collector 170 to the coupling protrusion 160, prior to the operation of welding the coupling protrusion and the terminal (S190). In an embodiment, when the coupling protrusion 160 is inserted into the current collector through hole 174 such that the flange portion 168 of the coupling protrusion 160 is seated in the annular groove 176 and a laser beam is emitted along the edge of the outer peripheral surface of the flange portion 168 and the edge of the inner peripheral surface of the annular groove 176, the annular weld portion 178 may be formed and thus the coupling protrusion 160 and the current collector 170 may be welded.

Referring to FIGS. 3, 5, and 10, the operation of welding the coupling protrusion and the terminal (S190) is an operation of inserting the coupling protrusion 160 to pass through the cap plate 121 and the terminal 140 and welding the coupling protrusion 160 and the terminal 140. In an embodiment, the coupling protrusion 160 to which the current collector 170 is joined is inserted into the cap plate through hole 122 with the joint portion 162 as a head such that the joint portion 162 is brought into surface contact with the inner peripheral surface of the terminal through hole 143.

In this way, when a laser beam is emitted along the edge of the outer circumferential surface of the joint portion 162 and the edge of the inner peripheral surface of the terminal through hole 143 of the terminal 140 in the state in which the joint portion 162 is in surface contact with the inner peripheral surface of the terminal through hole 143, the annular weld portion 158 may be formed and, thus, the coupling protrusion 160 and the terminal 140 may be welded. When the coupling protrusion 160 and the terminal 140 are welded, the second insulator 196 may be interposed between the cap plate 121 and the current collector 170.

Referring to FIGS. 2 and 4, the operation of inserting the electrode assembly into the cell case (S200) is an operation of inserting the electrode assembly 110 into the cell case 101 through the openings 105 and 107 formed in the cell case 101. The electrode assembly 110 may be inserted into the cell case 101 through one of the first opening 105 and the second opening 107.

The operation of installing a cap plate assembly (S300) is an operation of installing the cap plate assembly 120 on the cell case 101 to close the openings 105 and 107. A pair of cap plate assemblies 120 may be installed to close the first opening 105 and the second opening 107. In the operation of installing a cap plate assembly (S300), the cap plate 121 may be welded to the peripheries of the openings 105 and 107.

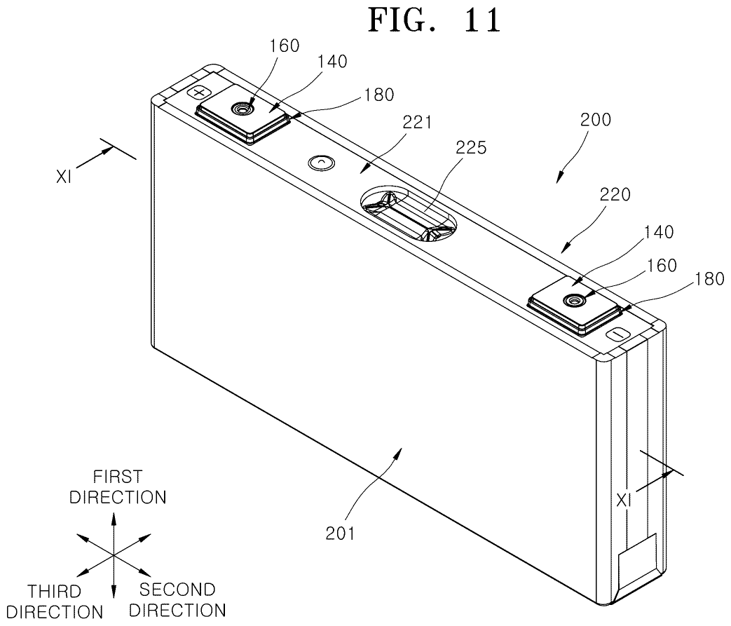

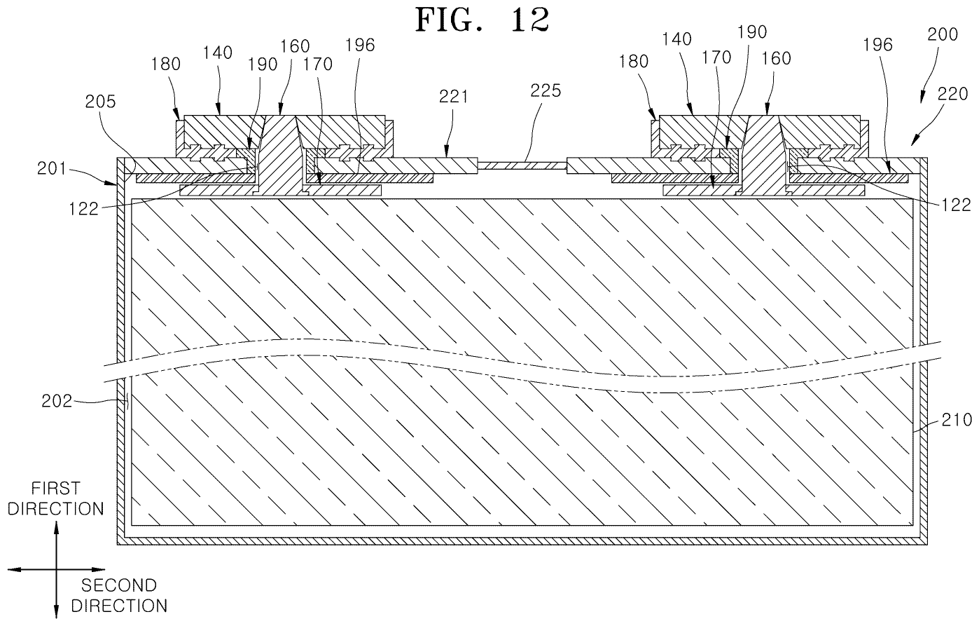

FIG. 11 is a perspective view of a battery cell according to another embodiment of the present disclosure; and FIG. 12 is a cross-sectional view taken along the line XI-XI in FIG. 11. Referring to FIGS. 11 and 12, a battery cell 200 according to another embodiment of the present disclosure includes a cell case 201, an electrode assembly 210, and a cap plate assembly 220.

In an embodiment, the cell case 201 is made of a metal material, for example, an aluminum alloy, and may be formed in an approximately rectangular parallelepiped shape. An internal space 202 in which the electrode assembly 210 is stored may be formed inside the cell case 201. An opening 205 open in a first direction may be formed in a side of the cell case 201.

The electrode assembly 210 may be accommodated inside the cell case 201. The electrode assembly 210 may enter the internal space 202 of the cell case 201 through the opening 205. The electrode assembly 210 may be formed by winding or stacking a stack of a first electrode plate, a separator, and a second electrode plate, which are formed in a thin plate or film shape. The electrode assembly 210 may have the same structure as the electrode assembly 110 included in the battery cell 100 according to the previously described embodiment of the present disclosure, and a redundant description thereof will be omitted.

The cap plate assembly 220 includes a cap plate 221, a terminal 140, a first insulator 180, a coupling protrusion 160, a current collector 170, a gasket 190, a second insulator 196, and a cell vent 225. The cap plate 221 closes the opening 205. In an embodiment, an outer edge of the cap plate 221 may be welded to an inner surface of the opening 205 of the cell case 201.

In an embodiment, the cap plate 221 may be a plate-shaped member of which a planar shape is approximately rectangular and may extend in a second direction perpendicular to the first direction. A pair of cap plate through holes 122 passing through the cap plate 221 in a thickness direction are formed at both, or opposite, ends of the cap plate 221 in a longitudinal direction. The cap plate 221 has a first uneven surface (not illustrated) in which a plurality of first recesses (not illustrated) are formed around the pair of cap plate through holes 122. A plurality of fine recesses (not illustrated) may be formed on the first uneven surface. The first uneven surface, the first recesses, and the fine recesses of the cap plate 221 may be the same as the first uneven surface 125, the first recesses 126, and the fine recesses 132 of the cap plate assembly 120 according to the previously described embodiment of the present disclosure, a redundant description thereof will be omitted.

A pair of terminals 140 of the cap plate assembly 220 are provided. The pair of terminals 140 may be disposed, one at each of both ends of the cap plate 221 in the longitudinal direction to be aligned with the pair of cap plate through holes 122 and spaced apart from each other along the second direction. One of the pair of terminals 140 may be a positive terminal and the other may be a negative terminal.

In the cap plate assembly 220, a pair of first insulators 180, a pair of coupling protrusions 160, a pair of current collectors 170, a pair of gaskets 190, and a pair of second insulators 196 may each be provided in a one-to-one correspondence with the pair of terminals 140.

Since the terminal 140, the first insulator 180, the coupling protrusion 160, the current collector 170, the gasket 190, and the second insulator 196 are denoted by the same reference numerals as the terminal 140, the first insulator 180, the coupling protrusion 160, the current collector 170, the gasket 190, and the second insulator 196 included in the cap plate assembly 120 according to the previously described embodiment of the present disclosure and may have the same configuration as those previously described, redundant descriptions of the configuration will be omitted.

One current collector 170 of the pair of current collectors 170 may be electrically connected to an uncoated portion of one of the first electrode plate and the second electrode plate of the electrode assembly 210, and the other current collector 170 may be electrically connected to an uncoated portion of the other of the first electrode plate and the second electrode plate of the electrode assembly 210.

In an embodiment, the current collector 170 may be directly electrically connected to the uncoated portion by a method such as welding or may be electrically connected to the uncoated portion via a sub-plate (not illustrated).

The cell vent 225 may be positioned between the pair of terminals 140 in the cap plate 221. The cell vent 225 may rupture and discharge emissions, such as a high-temperature gas or flame material, from the inside of the cell case 201 to the outside when the high-temperature gas or flame material is generated inside the cell case 201 due to overcharging, abnormal operation, or the like.

According to one or more embodiments of the present disclosure, a first insulator can be firmly coupled to a cap plate and a terminal, and a cap plate assembly including the cap plate, the terminal, and the first insulator can be easily manufactured by an insert injection molding method. Accordingly, productivity of a battery cell including the cap plate assembly can be improved and a cost thereof can be reduced.

In addition, electrical resistance between an electrode assembly and the terminal may be reduced, and, thus, power loss of the battery cell can be reduced and energy efficiency thereof can be improved.

While the present disclosure has been described with reference to some example embodiments shown in the drawings, these embodiments are merely illustrative and it is to be understood that various modifications and equivalent other embodiments can be derived by those skilled in the art on the basis of the embodiments. Therefore, the technical scope of the present disclosure should be defined by the claims.

What is claimed is:

1. A battery cell comprising:
an electrode assembly;
a cell case in which the electrode assembly is arranged, and comprising an opening to allow the electrode assembly to be inserted in the cell case; and
a cap plate assembly arranged on the cell case to close the opening,
wherein the cap plate assembly comprises:
a cap plate comprising a first uneven surface in which a plurality of first recesses is defined;
a terminal comprising a second uneven surface in which a plurality of second recesses is defined and which faces the first uneven surface; and
a first insulator filling the plurality of first recesses and the plurality of second recesses and located between the first uneven surface and the second uneven surface.

2. The battery cell as claimed in claim 1, wherein a size of an inner diameter of an entrance of each of the first recesses is smaller than a size of a greatest inner diameter among sizes of inner diameters of parts other than the entrance of the first recess, and
a size of an inner diameter of an entrance of each of the second recesses is smaller than a size of a greatest inner diameter among sizes of inner diameters of parts other than the entrance of the second recess.

3. The battery cell as claimed in claim 1, wherein the first insulator comprises:
a plurality of first hook protrusions formed by filling interiors of the plurality of first recesses with molten synthetic resin and curing the synthetic resin; and
a plurality of second hook protrusions formed by filling interiors of the plurality of second recesses with the molten synthetic resin and curing the synthetic resin.

4. The battery cell as claimed in claim 1, wherein a plurality of fine recesses is defined in at least one of the first uneven surface and the second uneven surface by laser irradiation, and
the first insulator comprises a plurality of fine protrusions formed by filling interiors of the plurality of fine recesses with molten synthetic resin and curing the synthetic resin.

5. The battery cell as claimed in claim 1, wherein a first through hole is defined in the cap plate,
a second through hole aligned with the first through hole is defined in the terminal, and
the cap plate assembly further comprises:
a coupling protrusion electrically coupled to the terminal through the first through hole and the second through hole;
a current collector arranged on a side opposite to the terminal with the cap plate therebetween and electrically coupled to the coupling protrusion; and
a second insulator between the cap plate and the current collector.

6. The battery cell as claimed in claim 5, wherein the cap plate assembly further comprises a gasket covering an inner peripheral surface of the first through hole and being in elastic contact with the inner peripheral surface of the first through hole.

7. The battery cell as claimed in claim 5, wherein the coupling protrusion and the terminal are coupled by welding.

8. The battery cell as claimed in claim 7, wherein the coupling protrusion comprises:
a pillar portion extending from the current collector toward the terminal with a constant diameter; and
a joint portion positioned farther from the current collector than the pillar portion and being tapered such that a diameter thereof becomes smaller as a distance from the current collector increases, and
the joint portion is welded to the terminal.

9. The battery cell as claimed in claim 8, wherein the second through hole is tapered such that a size of an inner diameter thereof becomes smaller as a distance from the cap plate increases, and
a size of an inclination angle of the tapered joint portion and a size of an inclination angle of the tapered second through hole are the same.

10. The battery cell as claimed in claim 8, wherein the coupling protrusion further comprises an assembly portion tapered such that a diameter thereof becomes smaller as a distance from the current collector increases between the pillar portion and the joint portion, and
a size of an inclination angle of the tapered joint portion is greater than a size of an inclination angle of the tapered assembly portion.

11. The battery cell as claimed in claim 1, wherein the terminal comprises a pair of terminals arranged to be spaced apart from each other along a longitudinal direction of the cap plate, and
the first insulator comprises a pair of first insulators arranged in a one-to-one correspondence with the pair of terminals.

12. The battery cell as claimed in claim 1, wherein the opening comprises a pair of openings open in opposite directions in the cell case, and
the cap plate assembly comprises a pair of cap plate assemblies arranged in a one-to-one correspondence with the pair of openings.

13. The battery cell as claimed in claim 1, wherein the terminal comprises a pair of terminals arranged to be spaced apart from each other along a longitudinal direction of the cap plate, and
the first insulator comprises a pair of first insulators arranged in a one-to-one correspondence with the pair of terminals.

14. A battery cell manufacturing method, the method comprising:
manufacturing a cap plate assembly;
inserting an electrode assembly into a cell case through an opening of the cell case; and
installing the cap plate assembly on the cell case to close the opening,
wherein the manufacturing of the cap plate assembly comprises:
preparing a cap plate comprising a first uneven surface in which a plurality of first recesses is defined;
preparing a terminal comprising a second uneven surface in which a plurality of second recesses is defined;
setting the cap plate and the terminal by inserting and fixing the cap plate and the terminal into an injection molding die such that the first uneven surface and the second uneven surface are arranged to face each other in the injection molding die;
molding a first insulator filling the plurality of first recesses and the plurality of second recesses and located between the first uneven surface and the second uneven surface by injecting molten synthetic resin into the injection molding die and curing the synthetic resin; and
removing the cap plate assembly including the cap plate, the terminal, and the first insulator from the injection molding die.

15. The battery cell manufacturing method as claimed in claim 14, wherein the preparing of the cap plate comprises:
forming a plurality of first basic grooves with a constant inner diameter from an entrance to a bottom in a surface of the cap plate by press machining; and
forming a first undercut by pressing a periphery of the entrance of each of the plurality of first basic grooves such that a size of the inner diameter of the entrance of each of the plurality of first basic grooves is smaller than a size of an inner diameter of a part other than the entrance of each of the plurality of first basic grooves.

16. The battery cell manufacturing method as claimed in claim 15, wherein the preparing of the terminal comprises:
forming a plurality of second basic grooves with a constant inner diameter from an entrance to a bottom in a surface of the terminal by press machining; and
forming a second undercut by pressing a periphery of the entrance of each of the plurality of second basic grooves such that a size of the inner diameter of the entrance of each of the plurality of second basic grooves is smaller than a size of an inner diameter of a part other than the entrance of each of the plurality of second basic grooves.

17. The battery cell manufacturing method as claimed in claim 14, wherein the manufacturing of the cap plate assembly further comprises forming a plurality of fine recesses by emitting a laser to at least one of the first uneven surface and the second uneven surface, and
in the molding of the first insulator, the first insulator is formed to fill the plurality of fine recesses.

18. The battery cell manufacturing method as claimed in claim 14, wherein the manufacturing of the cap plate assembly further comprises:
inserting a coupling protrusion to pass through the cap plate and the terminal, and welding the coupling protrusion and the terminal; and
welding a current collector to the coupling protrusion prior to welding the coupling protrusion and the terminal.

19. The battery cell manufacturing method as claimed in claim 18, wherein in the molding of the first insulator, a second insulator arranged to be spaced apart from the first insulator with the cap plate therebetween is formed together with the first insulator.

20. The battery cell manufacturing method as claimed in claim 19, wherein the manufacturing of the cap plate assembly further comprises installing a gasket on the cap plate prior to the setting of the cap plate and the terminal, and
in the molding of the first insulator, the first insulator is formed to be attached to a side of the gasket, and the second insulator is formed to be attached to another side of the gasket.
